(19) United States
(12) Patent Application Publication
(10) Pub. No.: US 2024/0315500 A1
(43) Pub. Date: Sep. 26, 2024

(54) TOILET SEATS, TOILET SEAT ADAPTERS AND SYSTEMS

(71) Applicant: Eric MARTIN, Auburn, NY (US)

(72) Inventor: Eric MARTIN, Auburn, NY (US)

(21) Appl. No.: 18/579,642

(22) PCT Filed: Jul. 22, 2022
(86) PCT No.: PCT/US2022/038082

§ 371 Date: Jan. 16, 2024

Related U.S. Application Data
(60) Provisional application No. 63/225,267, filed on Jul. 23, 2021.
(60) Provisional application No. 63/269,981, filed on Mar. 27, 2022.

(51) Int. Cl. A47K 13/24

(52) U.S. Cl. CPC A47K 13/24

(57) ABSTRACT

Systems, devices and methods adaptable for use with or as a toilet seat to assist in a bowel movement. The systems and devices may include one or more projections extending upward to be desirably positioned relative to body parts while the user is seated on a toilet seat having the one or more projections.

### CROSS-REFERENCE

This application claims the benefit of U.S. Provisional Application No. 63/225,267 filed Jul. 23, 2021, and 63/269,981 filed Mar. 27, 2022, which applications are incorporated herein in their entirety by reference.

### BACKGROUND

A combination of muscles and tissue work together in order to control a person's bowel movement. FIG. 1A illustrates a side view of human anatomy with exemplary internal muscles, organs, and tissue structure. The pelvic floor 12, anal sphincter 14, and puborectalis muscle 16 work together to open and close the passage to the rectum 20 which permits stool retained therein to be held or to pass to the rectal outlet 22. In some instances these organs do not work together to fully open the rectal passage between the rectal outlet 22 and the rectum 20. When the rectal passage is not fully opened, it may be difficult to achieve a full release of the stool from within the rectum 20. A first arrow 30 indicates a location to apply pressure to assist in releasing the anal sphincter to allow passage of stool from the rectum 20.

There have been attempts to assist these organs to align and permit easier passage of stool from the rectum 20 to the rectal outlet 22. For example, a footstool can be provided which the person sitting on a toilet may bring their knees up in order to mimic a squatting position. This position may permit the alignment of the organs and orient the passage from the rectum to the rectal outlet in a straighter and more open position, and may work with the organs to assist in passage of stool.

What is needed, however, is an easy to use toilet seat or adapter which is configured to apply pressure to the pelvic floor in order to assist in releasing the anal sphincter to allow stool to pass from the rectum.

### SUMMARY

Exemplary embodiments show and describe systems and methods for toilet seats or adapters operable to assist a user in fully excreting a bowel movement.

Both the foregoing general description and the following detailed description are exemplary and explanatory only and are not restrictive of the disclosed embodiments.

Toilet seats and toilet seat adapters are described. The toilet seats and/or adapters comprise: one or more upward pressure applying projection creating a surface extending upward from the toilet seat when the projection is attached to the toilet seat. The pressure applying projection can extend away from an upper surface of the toilet seat at a rear location of an interior opening of the toilet seat or be incorporated into an adapter that is applied to a toilet seat. The pressure applying projection can comprise a concave upward surface. Additionally, the upper surface of the toilet seat can be inclined downward from an exterior edge toward an interior edge defining the interior opening. Toilet seat adapters can be adhered to the toilet seat or rotationally pivot from the upper surface of the toilet seat. In another configuration, the pressure applying projection comprises a stem (e.g., a rod or elongated tubular member), a collar positioned around the stem and a counterweight on an opposite end of the stem from the top portion. The top portion of the pressure applying projection can further comprise a convex curved surface as referenced from above the toilet seat and the projection. An attachment portion can be provided that is a rotational attachment to a same rotational axis as the toilet seat, a surface configured to extend along a side of the toilet seat and around interior and exterior sides of the toilet seat to clamp onto a portion of the toilet seat, or an extension on opposing sides of the projection configured to contact and extend from opposite sides of the toilet seat, wherein the opposite sides of the toilet seat comprise the interior edges of the toilet seat proximate to an opening in the toilet seat. In some configurations the projection is coupled to a toilet seat and is configured to be positioned in an area between the tailbone of a user and the rectal outlet when the user is seated on a toilet seat or configured to be positioned in an area between the rectal outlet and a front of a pelvic bone of a user when the user is seated on the toilet seat. Pressure applied in this area is referred to as rostral pressure.

Another aspect of the disclosure is directed to methods of using a toilet seat configured with one or two pressure applying projections, wherein pressure is applied to at least one of an area between the tailbone of a user and the rectal outlet and a front of a pelvic bone of a user when the user is seated on the toilet seat.

### INCORPORATION BY REFERENCE

All publications, patents, and patent applications mentioned in this specification are herein incorporated by reference to the same extent as if each individual publication, patent, or patent application was specifically and individually indicated to be incorporated by reference.
U.S. Pat. No. 2,256,994 A issued Sep. 23, 1941;
U.S. Pat. No. 4,048,679 A issued Sep. 20, 1977;
U.S. Pat. No. 4,189,794 A issued Feb. 26, 1980;
U.S. Pat. No. 4,244,063 A issued Jan. 13, 1981;
U.S. Pat. No. 4,457,029 A issued Jul. 3, 1984;
U.S. Pat. No. 6,584,621 B2 issued Jul. 1, 2003;
U.S. Pat. No. 7,971,285 B2 issued Jul. 5, 2011;
U.S. Pat. No. 10,064,497 B2 issued Sep. 4, 2018;
U.S. Pat. No. 10,123,669 B2 issued Nov. 13, 2018;
U.S. Pat. No. 10,959,582 B2 issued Mar. 30, 2021;
U.S. Pat. No. 11,253,116 B2 issued Feb. 22, 2022;
U.S. Pat. No. 11,253,117 B2 issued Feb. 22, 2022;
U.S. Publication 2009/0265843 A1 published Oct. 29, 2009; and
U.S. Design Des 944,369 issued Feb. 22, 2022.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A illustrates a partial internal view of relevant human anatomy that assist in a bowel movement;

FIG. 1B illustrates the human anatomy of FIG. 1A with areas of pressure identified.

FIGS. 2A-L illustrate exemplary toilet seats according to the disclosure;

FIG. 3 illustrates an exemplary toilet seat adapter according to the disclosure;

FIGS. 4A-E illustrate exemplary toilet seat adapters according to the disclosure;

FIG. 5 illustrates an exemplary toilet seat with an adapter; and

FIGS. 6A-D illustrate exemplary toilet seats according to the disclosure.

### DETAILED DESCRIPTION

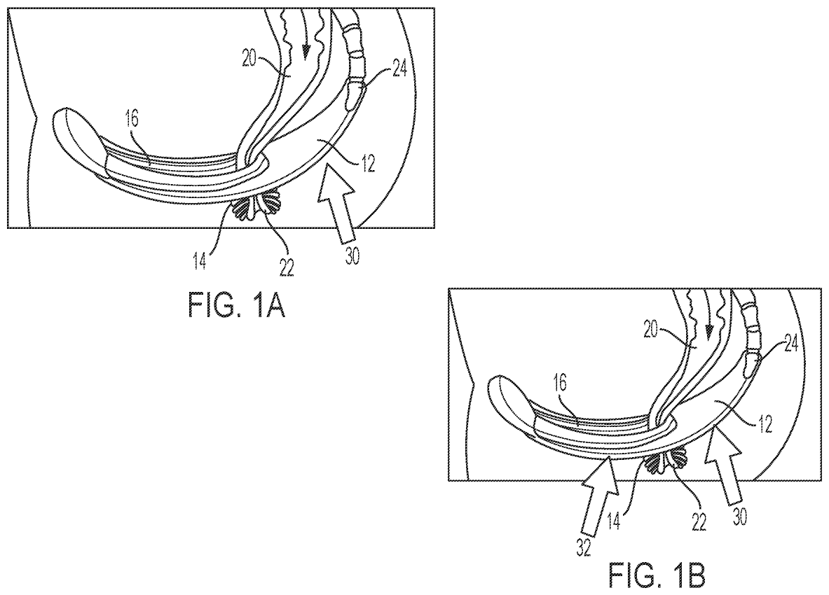

Turning now to FIG. 1B the partial internal view of the anatomy that assists in a bowel movement shown in FIG. 1A is illustrated. As illustrated previously, a first arrow 30 indicates an anatomical location for applying pressure by, for example, a first projection located on a toilet seat or toilet seat adapter. The first a target anatomical location corresponds to the location of the anococcygeal raphe. Pressure is applied between the rectal outlet 22 and the tailbone 24 which results in a release of the pelvic floor 12. Pressure applied in this area is referred to as rostral pressure. A second arrow 32 indicates a target anatomical location for applying pressure by, for example, a second projection on a toilet seat or toilet seat adapter. The second target anatomical location corresponds to the location of the perineal body. Pressure is applied on an opposite side of the rectal outlet 22 than the first arrow 30. The second projection is positioned to contact an area in front of the user's rectal outlet 22 toward the puborectalis muscle 16. The toilet seats or adapters are configurable to apply pressure to one or more of the target pressure points to straighten or align the passage before the rectal outlet 22 to assist in an easier bowel movement for users or a more complete excretion of material from the rectum 20.

### I. Toilet Seats and Toilet Seat Adapters

The toilet seat 200 has an upper surface, a lower surface, a first lateral side, a second lateral side and a rear lateral side between the first lateral side and the second lateral side. An opening is defined between the first lateral side, the second lateral side, and the rear lateral side. The opening allows passage of urine and fecal matter from a user seated on the toilet seat to, for example, a toilet bowl. Some toilet seats can also have a front lateral side. A convex surface extends upward from the rear lateral side of the upper surface. The convex surface is positioned so that it is operable to apply pressure to a target area between the rectal outlet 22 and the tailbone 24 which results in a release of the pelvic floor 12. A concave curved surface is positioned on the rear lateral side of the upper surface adjacent the convex upward extending surface. The concave curved surface forms a shallow channel along the rear lateral side of the toilet seat. The upper surface, lower surface, first lateral side, second lateral side, rear lateral side and opening of the toilet seat define a curved outer edge from a top view, and a curved inner edge from the top view. The upper surface of the rear lateral side curves downward from the outer edge of the rear lateral side from a side view into the convex surface, and then curves upward into the concave curved surface. The concave curved surface can further include a tip. In some configurations, the concave curved surface is moveable in a forward and backward direction. Moving the concave curved surface allows for a change in location of the application of pressure during use. The toilet seat can also include a lid rotatably connected to the seat.

Toilet seat adapters are also disclosed. The toilet seat adapters comprise: an upper surface, a lower surface, a first lateral side, a second lateral side and a rear lateral side between the first lateral side and the second lateral side and a front lateral side between the first lateral side and the second lateral side at opposite the rear lateral side, wherein one of the upper surface and the lower surface is operable to engage a toilet seat; and a tip extending upward from the upper surface of the front lateral side above an upper surface of the toilet seat. The adapter can include a first curved surface configured to contact a first exterior curved surface of the toilet seat and a second curved surface configured to contact a second exterior curved surface of the toilet seat. The toilet seat adapter can include an adhesive for securing the toilet seat adapter to the toilet seat. The adhesive can be any suitable adhesive, either permanent or temporary and removable. A suction cup for securing the toilet seat adapter to the toilet seat. The tip can also be flexible. The tip has a first width at a distal end and a second width larger that the first width proximal to the distal end. The tip can also be laterally moveable. Moving the tip allows for a change in location of the application of pressure during use.

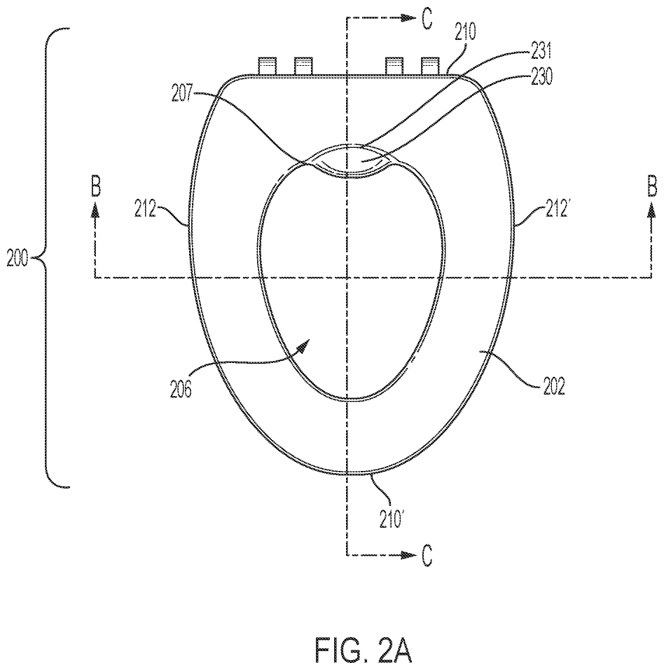

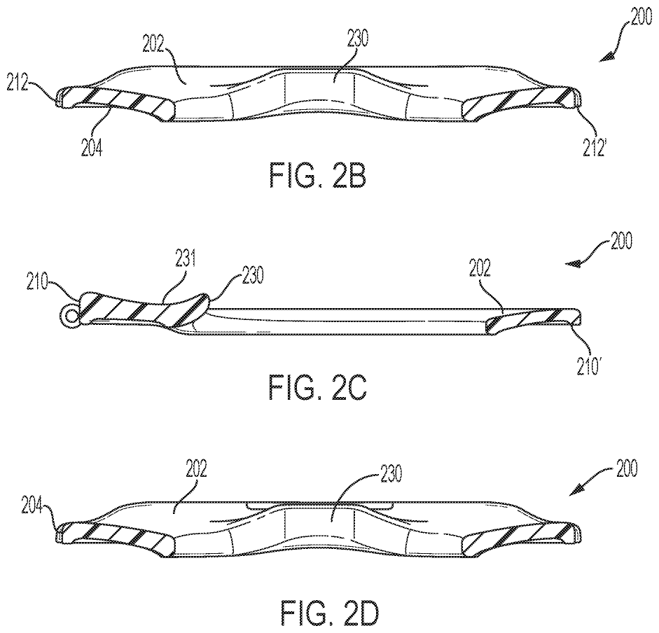

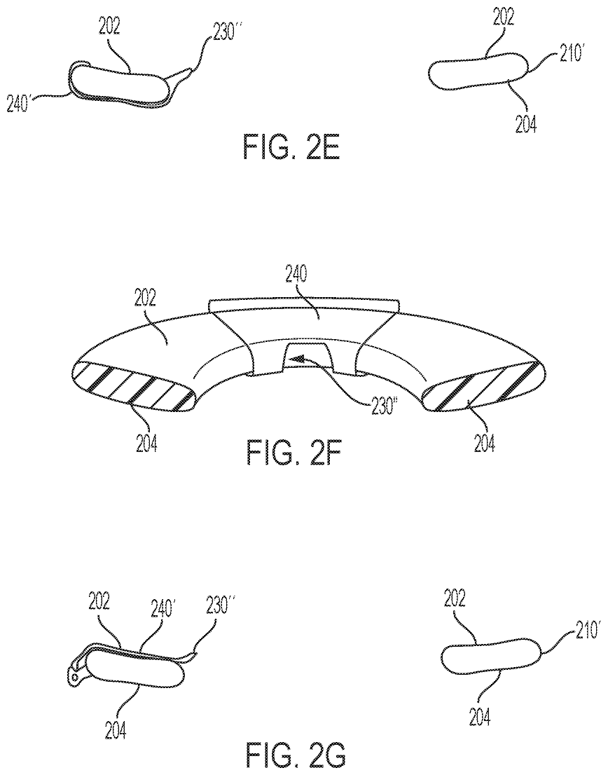

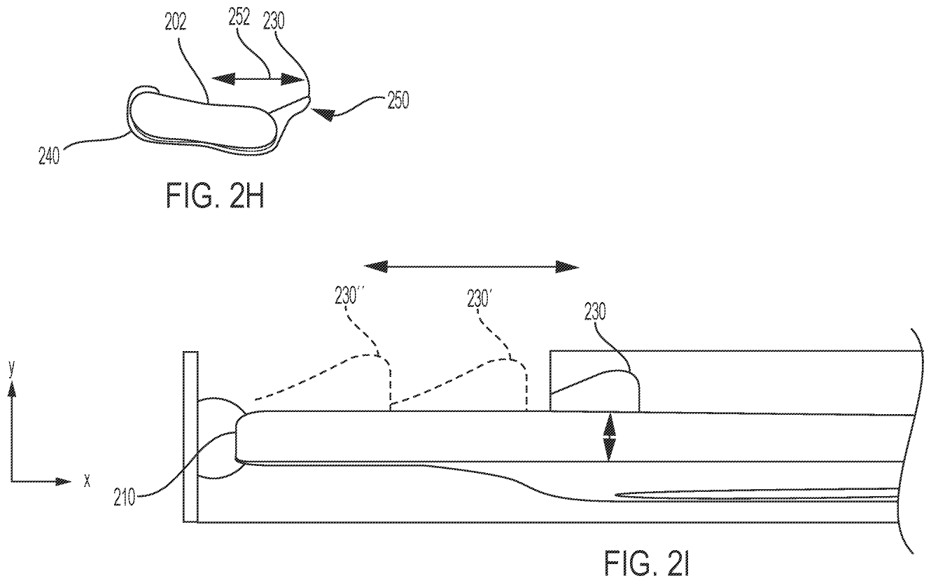

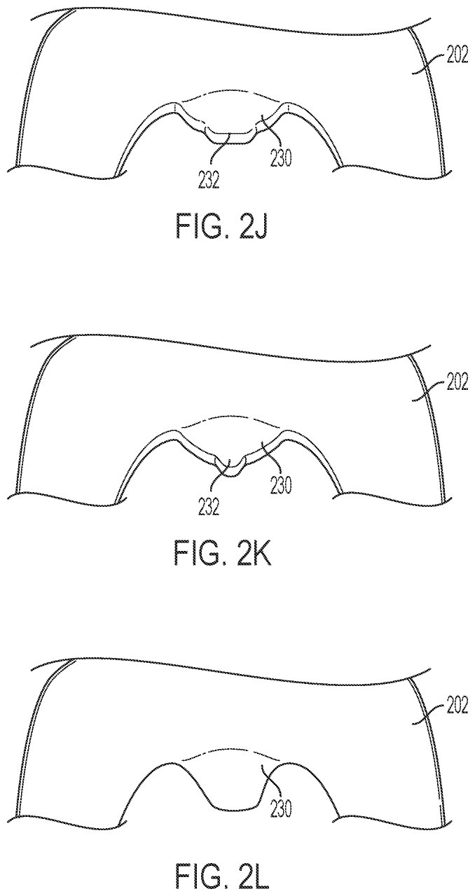

Turning now to specific exemplar embodiments of toilet seats and toilet seat adapters, FIG. 2A illustrates an exemplary toilet seat 200 according to the disclosure. FIGS. 2B-2C illustrate exemplary cross sections of the toilet seat 200 of FIG. 2A. As illustrated, an exemplary toilet seat 200 comprises an upper seat surface 202. The toilet seat 200 is typically configured to define a full or partial circular or elongated circular structure. The toilet seat 200 is similar to commercially available toilet seats wherein the toilet seat 200 is sized and oriented to support the butt and/or portion of the upper leg of a user as they sit on a toilet. The toilet seat 200 defines a toilet seat opening 206. The toilet seat opening 206 is positioned to permit the user to pass bodily excrement through the toilet seat opening 206 of the toilet seat 200 and into a container below (such as a toilet bowl), e.g. by being positioned anatomically below the rectal outlet of the user. As would be appreciated, the toilet seat 200 may include a full circumference to fully encircle and define the toilet seat opening 206 or may include one or more gaps. The toilet seat 200 may be generally circular, ovoid, or other shape the circumscribes the opening for more than half of a revolution, whether in one or more parts thereof. The toilet seat 200 may include generally straight portions and/or generally curved portion to define the circumferential shape about the opening. The toilet seat 200 may also include an attachment mechanism to couple the toilet seat 200 to another structure such as a toilet bowl. Such attachment mechanism may include a hinge to permit the toilet seat to be raised and lowered for selective use.

The toilet seat 200 has an upper seat surface 202 (top surface) and a lower surface 204 (bottom surface) opposing the upper seat surface 202 and an toilet seat opening 206. The upper seat surface 202 may include a downward slope from a rear surface 210 such that sides 212, 212′ of the toilet seat 200 on the upper seat surface 202 are at a lower elevation than the rear surface 210 of the upper seat surface 202. The orientation may be in an in use orientation, such that the toilet seat 200 is generally horizontal and configured to permit a user to sit upon the upper seat surface 202 of the toilet seat 200 and pass a bowel movement through the toilet seat opening 206.

An outlet-tailbone projection 230 is provided at the rear 207 of the toilet seat opening 206 nearest the rear surface 210 of the toilet seat 200. The outlet-tailbone projection 230 can, as shown in FIG. 2A form a convex shape that projects into the toilet seat opening 206 of the toilet seat 200 from an upper seat surface view. The upper seat surface can also have a concave curved surface 231 prior to the outlet-tailbone projection 230, as is appreciated in FIG. 2C. The concave curved surface 231 can create a recess that is aligned with a curvature of the toilet seat opening 206 between each end of the outlet-tailbone projection 230. The position of the outlet-tailbone projection 230 is sized and configured to apply pressure between the rectal outlet 22 and the tailbone 24 (shown in FIGS. 1A-1B).

FIG. 2B illustrates an exemplary toilet seat 200 in cross-section, taken along the lines B-B in FIG. 2A. From this perspective the contour of the upper seat surface 202 of the toilet seat 200 can be appreciated. In this view, the outlet-tailbone projection 230 extends upward from the upper seat surface 202 of the toilet seat 200 to provide an upwardly curved pressure projection or tip.

FIG. 2C an exemplary toilet seat 200 in cross-section, taken along the lines C-C in FIG. 2A. From this view, it will be appreciated that the upper seat surface 202 is sloped downward from a higher elevation adjacent an exterior edge of the toilet seat portion to a lower elevation adjacent an interior edge of the toilet seat portion at the toilet seat opening 206. Other configurations may also be used, such as a convex upward shape so that the upper seat surface 202 defines a curve with a higher elevation adjacent an interior of the upper seat surface between the exterior edge and the interior edge. In an example, the upper seat surface 202 may be contoured to assist in the spreading of a user's bottom cheeks to expose and open the anal opening and passage. For example, on opposing sides of the opening, the upper seat surface 202 may be positioned and oriented such that as a user's checks contact the upper seat surface 202, the user sits within a space created within the upper seat surface and the user's checks are spread apart as the user sits within the space.

The toilet seat 200 can include an outlet-tailbone projection 230. The outlet-tailbone projection 230 is shaped and configured to extend upward from the upper seat surface 202 of the toilet seat 200. The outlet-tailbone projection 230 may comprise a smooth transition from a downward sloping portion and/or from a lower portion of the upper seat surface 202 upward into an upwardly extending surface of the projection. The outlet-tailbone projection 230 may also transition from the upper seat surface in a discontinuous fashion, such that the outlet-tailbone projection 230 is angled relative to the upper seat surface 202 of the toilet seat 200. The outlet-tailbone projection 230 may also extend upwardly, away from the upper seat surface 202 (regardless of the orientation of the upper seat surface-whether sloped or flat), and toward a toilet seat opening 206 of the toilet seat 200.

The cross-section of the toilet seat 200 shown in FIG. 2C extends through a portion of the outlet-tailbone projection 230. As illustrated, the outlet-tailbone projection 230 extends upward above at least a portion of the upper seat surface 202 of the toilet seat 200 and away from the toilet seat portion in contact with the projection, toward an opposite side of the toilet seat portion. The outlet-tailbone projection 230 therefore may extend into a space above the toilet seat opening.

As will be appreciated by those skilled in the art, FIGS. 1A-1C illustrate an example in which the outlet-tailbone projection 230 may be integrated into the toilet seat 200. The outlet-tailbone projection 230 may be permanently connected to, integrally formed with, or otherwise integrated into the toilet seat 200. The outlet-tailbone projection 230 may therefore move with the toilet seat 200 as the toilet seat 200 is transitioned between a lowered orientation for seating or in a raised orientation so that it is out of the way of the lower toilet bowel.

Turning now to FIGS. 2D-2E illustrate an alternate where the outlet-tailbone projection 230′ may be coupled to and/or removable from the toilet seat 200. For example, the outlet-tailbone projection 230′ may integrally formed as part of an adapter 240. The adapter 240 can have a convex surface and a concave surface and be configurable to fit around a portion of the toilet seat 200. FIGS. 2D-F illustrate the adapter 240 being secured to the toilet seat 200 so that the concave surface of the adapter 240 surrounds the lower surface of the toilet seat and exposes a portion of the upper surface of the toilet seat. The adapter 240 may comprise a generally C-shape that is configured to couple around a portion of the toilet seat 200. The interior of the C-shape may be considered the concave surface and the exterior of the C-shape may be considered the convex surface. The outlet-tailbone projection 230′ may be integrally formed with adapter and extend from an exterior surface of the adapter 240. The adapter 240 may also comprise other attachment configurations, such as clamps, screws, pressure grips, adjustable dimension clamps, hooks, adhesive, etc., to facilitate attaching the adapter 240 to the toilet seat 200. Other attachment mechanisms described herein or otherwise known to a person of skill in the art can be used without departing from the scope of the disclosure. Additionally, combinations of attachment mechanisms can be used. Additionally, as will be appreciated by those skilled in in the art, the adapter 240 could also be configured so that the concave surface surrounds the upper surface of the toilet seat and exposes a portion of the lower surface of the toilet seat. In either configuration, the outlet-tailbone projection 230′ is positioned so that it is optimally located to apply pressure between the rectal outlet 22 and the tailbone 24 (shown in FIGS. 1A-1B) when the toilet seat is in use.

FIGS. 2F-2G illustrate another of an adapter 240′ in which the outlet-tailbone projection 230″ may be indirectly coupled to and/or separable from the toilet seat 200. The toilet seat 200 may be any commercially available toilet seat. The toilet seat 200 may also be sold with an adapter, such as those described herein, such that the toilet seat 200, and the outlet-tailbone projection 230″ share a common rotational connection interface to be coupled to a toilet base. The toilet seat 200 can be used with or without the outlet-tailbone projection 230″ by repositioning the outlet-tailbone projection 230″ into a use position (or deployed position) or in an out-of-use position (or un-deployed position). The outlet-tailbone projection 230″ can be coupled to the toilet seat 200 and moveable relative to the toilet seat, while being secured thereto. The outlet-tailbone projection 230″ and/or the toilet seat 200 may be rotationally coupled to a mount and/or the toilet base. The mount may be coupled to the toilet base. The outlet-tailbone projection 230″ may comprise a surface that extends from the rotational connection of the mount. The surface generally conform to a upper seat surface 202 of the toilet seat 200. The upper seat surface 202 may be integrally coupled to the outlet-tailbone projection 230″. The outlet-tailbone projection 230″ may therefore be positioned to contact the upper surface 202 of the toilet seat 200 and create a configuration as described herein of the outlet-tailbone projection 230″ as described with respect to other pressure application projections described herein.

Exemplary embodiments of the toilet seat 200 described herein may also include a toilet seat lid (not shown). An underside of the toilet seat lid may be configured to accept a portion of the outlet-tailbone projection or otherwise have a mating surface to the outlet-tailbone projection such that the outlet-tailbone projection may fit within a portion of an indentation on the surface of the toilet seat lid. In this way, the toilet seat lid may rest against the toilet seat portion, while also accommodating the upward extension of the projection without interfering with the closure of the toilet seat lid. The underside and/or exterior side of the toilet seat lid may be configured or conformed. For example, the underside and/or exterior side of the toilet seat may be curved outward away from the opening of the toilet seat opening such that, when fully closed, the toilet seat may create a dome or partial dome shape. The upper surface of a toilet seat lid may be generally flat or planar to accommodate someone sitting thereon.

Turning to FIG. 2H, a cross-section of a toilet seat is shown with an adapter 240 encircling a portion of the toilet seat with the upper seat surface 202 exposed. Pressure applied at 250 outlet-tailbone projection 230 enables the outlet-tailbone projection 230 to move forward-and-backward along axis 252.

As shown in FIG. 2I, the outlet-tailbone projection 230 can be moved backwards along an x axis towards the rear surface 210 of the toilet seat, shows exemplar position 2 230′, and exemplar position 3 230″. Additionally, the moveable outlet-tailbone projection 230 can be associated with a outlet-tailbone projection 230 integrally formed with a toilet seat or a toilet seat adapter.

A portion of the toilet seat is shown in FIGS. 2J-2L. As will be appreciated in reviewing the figure, the shape of the outlet-tailbone projection 230 can have a variety of shapes from an upper perspective. The outlet-tailbone projection 230 can curve upward from the upper seat surface 202 of the toilet seat and feature a tip 232. The width of the tip 232 can vary compared to the width of the outlet-tailbone projection 230.

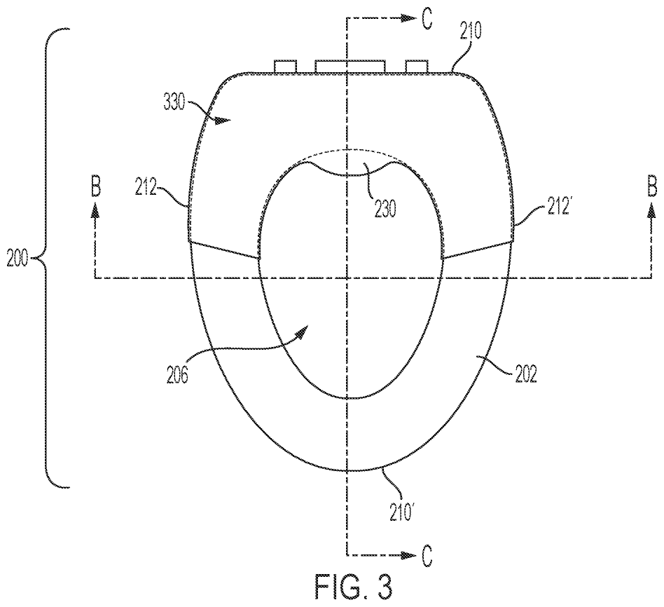

FIG. 3 illustrates a toilet seat 200 with an adapter 330. The adapter 330 is positioned to fit on top of the toilet seat 200. The adapter 330 can be permanently or impermanently adhered to the toilet seat 200, attached via a suction feature, or be removeably affixed using a snap fit where the adapter 330 has a curved surface that snaps around a portion of the toilet seat 200.

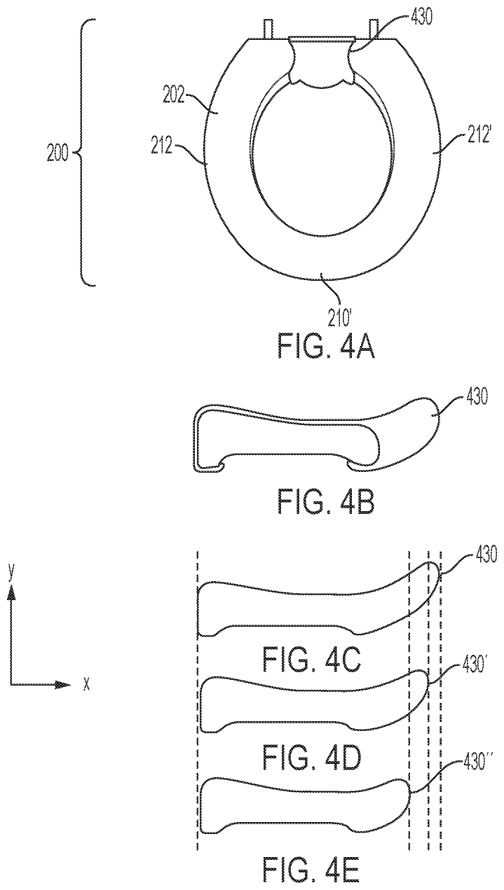

FIGS. 4A-4E illustrate a toilet seat 200 with an adapter 430. The adapter 430 is positioned so that it surrounds the upper seat surface 202 of the toilet seat 200. As shown in FIG. 4B, the side of the adapter 430. From a side perspective, shown in FIGS. 4C-4E, the adapter 430, 430′, 430″ can have a variety of lengths in an x direction and a variety of heights in a y direction. The adapter 430 can be permanently or impermanently adhered to the toilet seat 200, attached via a suction feature, or be removeably affixed using a snap fit where the adapter 430 has a curved surface that snaps around a portion of the toilet seat 200.

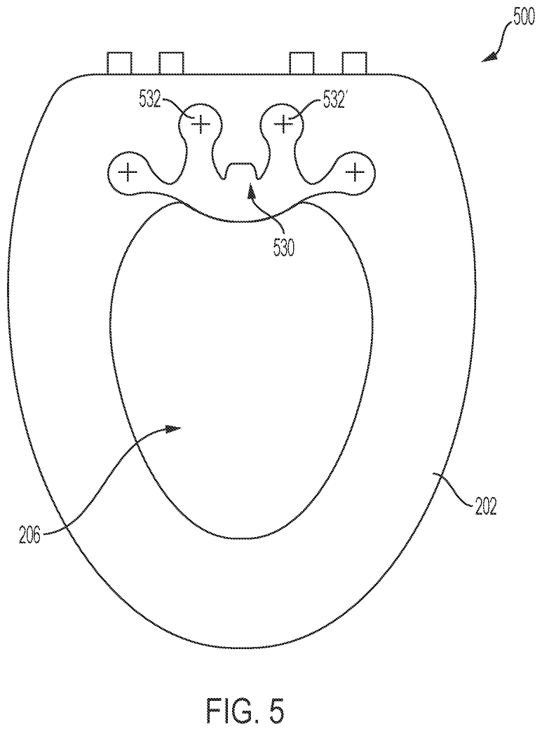

FIG. 5 illustrates another toilet seat 200 with adapter 530. Adapter 530 is configured to be attached to an upper seat surface 202 of the toilet seat 200. The adapter 530 has a plurality of extensions 532, 532′ which include suction cups or a removable adhesive layer. Alternatively, the adapter 530 can be permanently or impermanently adhered to the toilet seat 200.

A toilet seat can also comprise an upper surface, a lower surface, a first lateral side, a second lateral side and a rear lateral side between the first lateral side and the second lateral side, an opening defined between the first lateral side, the second lateral side, and the rear lateral side, and a lateral cross-member extending between the first lateral side and the second lateral side; and a protrusion extending from an upper surface of the lateral cross-member resulting in a portion of the opening being on one side of the lateral cross-member and a portion of the opening being on an opposing side of the lateral cross-member. The toilet seat can, of course, include a front lateral side. A lid can also be provided that is rotatably connected to the seat. The protrusion is positionable on a stem to provide an adjustable height. Adjusting the height of the protrusion results in a change in pressure applied to a target anatomy. A counterweight can also be provided that is positioned on an opposing end of the stem engaging the protrusion. The protrusion thus is positioned adjacent an upper surface of the lateral cross-member, and the counterweight is positioned adjacent a lower surface of the lateral cross-member.

A toilet seat adapter that includes a lateral cross-member configured to extend between a first lateral side of a toilet seat and a second lateral side of the toilet seat, and a protrusion extending from an upper surface of the lateral cross-member. The protrusion is positionable on a stem to provide an adjustable height. A counterweight can also be provided that is positioned on an opposing end of the stem engaging the protrusion.

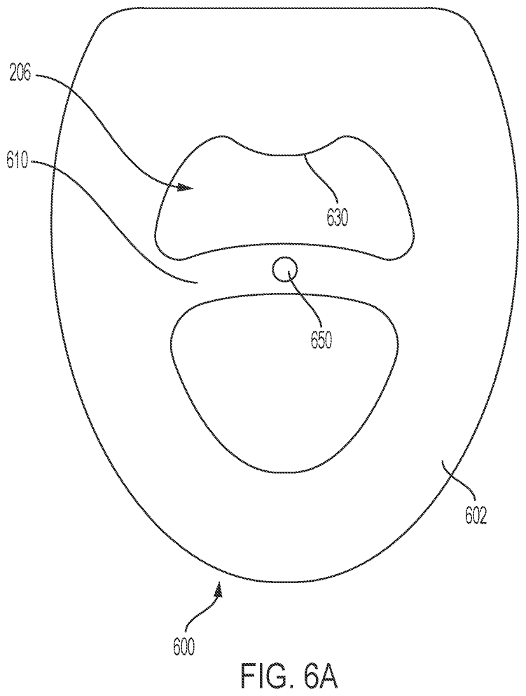

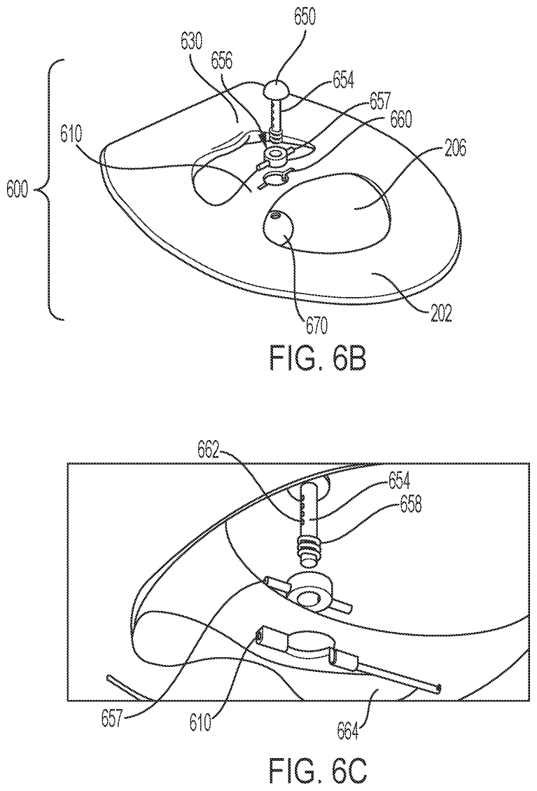

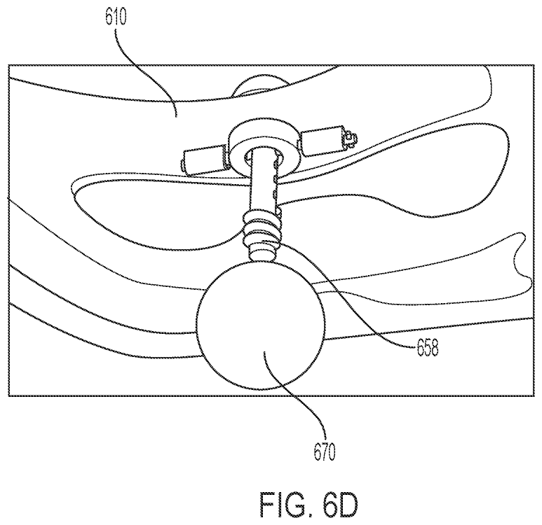

FIG. 6A illustrates an exemplary toilet seat 600 according to embodiments of the disclosure. FIGS. 6B-6D are partial perspective views or exploded component views of the toilet seat 600 of FIG. 6A. The toilet seat 600 has an upper seat surface 602, an outlet-tailbone projection 630, and a puborectalis-rectal pressure projection 650 extending from a lateral support 610 positioned between across the toilet seat opening 206. Although disclosed herein as having an outlet-tailbone projection 630, and a puborectalis-rectal pressure projection 650, persons of skill in the art will appreciate that either or both of the projections can be provided. The outlet-tailbone projection 630 may be removable or relatively positionable such that the outlet-tailbone projection 630 may be separated from the toilet seat 600. The toilet seat 600 may therefore be selectively used with the outlet-tailbone projection 630. The toilet seat 600 may have an upper seat surface 602 similar to any of the toilet seat portions described herein. The toilet seat 600 may therefore have a curved upper seat surface, an inward/downwardly sloped upper seat surface, flat upper seat surface, angled upper seat surface, and combinations thereof.

As illustrated the puborectalis-rectal pressure projection 650 may be positioned within and/or above the toilet seat opening 206. The puborectalis-rectal pressure projection 650 may be supported by a lateral support 610. The lateral support 610 may extend across the toilet seat opening 206 from one side thereof to an opposite side thereof. Similar to the projection described above with respect to FIGS. 2, the lateral support 652 may be integrated into, coupled thereto, removable therefrom, or rotationally positionable relative to the toilet seat 600. For example, the support may extend from or be integrally formed with the toilet seat 600. The lateral support 652 may end in a coupling interface to removably attach to the toilet seat 600. The coupling interface may be a c shaped clamp or other attachment method, such as belt, straps, buckle, camp, screw, adhesive, tape, other attachment described herein or otherwise known to a person of skill in the art, and any combination thereof. The support may be sized such that it touches a portion of the upper seat surface 202 of the toilet seat 600. It may therefore simply be positioned on the top of the toilet seat at the time of use and rest on the toilet seat during use.

FIGS. 6B-6C illustrate different exploded component part views of the puborectalis-rectal pressure projection 650 described herein. In an exemplary puborectalis-rectal pressure projection 650, the projection is configurable to be adjustable. The adjustment may be in a relative height of the projection above the toilet seat portion, the orientation of the projection, and angle of the projection, a size of the projection, or any combination thereof. For example, the puborectalis-rectal pressure projection 650 may include a stem 654 that mates with a collar 656. The stem 654 may include threads 658 that engaged with mated internal threads in the collar 656. The relative height of the top of the puborectalis-rectal pressure projection 650 may therefore be selectively set by rotating the puborectalis-rectal pressure projection 650 through the stem 654 relative to the collar 656. The collar 656 may include lateral projections 657. The lateral projection 657 from the collar 656 are illustrated as opposing stems extending from opposite sides of the collar 656. The lateral projections 657 may be supported by an indentation 660 within the lateral support 652. The lateral projections 657 may fit within the indentation to retain a relative position of the projections to the support. The interface of the lateral projections 657 to the indentation may permit the puborectalis-rectal pressure projection 650 to rotate about an axis of rotation through the lateral projections 657. The lateral projections 657 may therefore define different angles and/or relative forward/backward position to the toilet seat portion and/or support so that the puborectalis-rectal pressure projection 650 may be positioned in a desirable location for the user.

Alternative and/or additional adjustable attachments may be used for the puborectalis-rectal pressure projection 650 and the toilet seat 600. For example, the stem 654 may include apertures 662 in which a stem 654 may be positioned therethrough. The selection of one aperture instead of another of aperture may permit the selection of a height of the projection above the support and/or seat portion. The selection of an aperture may be by passing the stem 654 through an aperture of the plurality of apertures 662 to define a set distance between the stem 654 positioned in the aperture and a top of the puborectalis-rectal pressure projection 650. The stem 654 may be positioned through a support 668 defining a passage therethrough. The support 668 may be coupled to lateral support 652. The lateral support 652 between opposing sides of the toilet seat 600 may have an aperture or gap between the opposing sides. The stem 654 of the puborectalis-rectal pressure projection 650 may be configured to pass through the gap of the lateral support 652. The support 668 may be on opposing sides of the gap of the lateral support 652 to support the stem 654 as the stem is positioned through the gap.

Any of the stem 654, lateral projections 657, indentation 660, support 668 with passage or other surface may be keyed such that an angle or orientation of the puborectalis-rectal pressure projection 650 may be selected and retained. For example, the interface between mated surfaces may be in direct contact such that the surfaces frictionally engage. The surface may be moved (such as rotated) relative to each other, but with an application of a movement force, may be selectively positioned. With the absence of the movement force, the relative position of the mated surface is static. The interface may also be keyed such that the surface may interact at specific orientations and intentionally positioned within each orientation. For example, a geared or saw-tooth mated surface may be used so that a step-wise positioning of one surface to another may be selected and retained when one surface is mated to another surface. Other keyed or mated features may also be used. For example, the stem 654 may freely rotate within indentation 660 of lateral support 652, but with the insertion of the stem 654, the stem 654 and aperture may include a textured surface or mated shapes on the surfaces in contact, such that once the stem 654 is inserted, further rotation of the lateral projections 657 in the indentation 660 is prevented or reduced.

The lateral support 610 between opposing sides of the seat portion may have an aperture or gap between the opposing sides. A rod 664 of puborectalis-rectal pressure projection 650 may be configured to pass through the gap of the lateral support 610. The lateral support 610 may be on opposing sides of the gap of the lateral support 610 to support the rod 664 as the rod is positioned through the gap.

Any of the rod 664, puborectalis-rectal pressure projections 650, indentation 660, lateral support 610 with passage or other surface may be keyed such that an angle or orientation of the puborectalis-rectal pressure projection 650 may be selected and retained. For example, the interface between mated surfaces may be in direct contact such that the surfaces frictionally engage. The surface may be moved (such as rotated) relative to each other, but with an application of a movement force, may be selectively positioned. With the absence of the movement force, the relative position of the mated surface is static. The interface may also be keyed such that the surface may interact at specific orientations and intentionally positioned within each orientation. For example, a geared or saw-tooth mated surface may be used so that a step-wise positioning of one surface to another may be selected and retained when one surface is mated to another surface. Other keyed or mated features may also be used. For example, the rod 664 may freely rotate within indentation of lateral support 610, but with the insertion of the rod 664, the rod and aperture may include a textured surface or mated shapes on the surfaces in contact, such that once the rod 664 is inserted, further rotation of the puborectalis-rectal pressure projections 650 in the indentation 660 is prevented or reduced.

Additionally, the puborectalis-rectal pressure projection 650 is a ball or partial spherical shape. Any shape may, however, be used. The puborectalis-rectal pressure projection 650 may have a convex shape relative to a perspective above and exterior to the puborectalis-rectal pressure projection 650. The convex shape may facilitate a more ergonomic or comfortable surface to contact the human anatomy in the plurality of rotational orientations in which the projection may be positioned.

The puborectalis-rectal pressure projection 650 may include a counterweight 670. For example, instead of threading to collar 656, the stem 654 may pass through an opening in the collar 656 and maintain a height through insertion of the stem 654 through one or more of the apertures 662. The lower portion of the stem 654 may include threads 658. The threads 658 may be used to couple a counterweight 670. The counterweight 670 is illustrated as a ball, but such a configuration is not required. The counterweight may be used to rotationally reposition the puborectalis-rectal pressure projection 650 directly upward when not in use. The interface between mated surface is not keyed such that the projection may rotate about an axis defined by the stem 654. The user may select the orientation at the time of use. When the toilet seat is not in use, the counterweight 670 may reorient the projection into a resting position with a longitudinal axis approximately vertical.

### II. Toilet Seat Systems

A toilet seat adapter system is also provided that combines the features of the adapters described above with respect to FIGS. 2-6. The system comprises a first toilet seat adapter comprising an upper surface, a lower surface, a first lateral side, a second lateral side and a rear lateral side between the first lateral side and the second lateral side and a front lateral side between the first lateral side and the second lateral side at opposite the rear lateral side, wherein one of the upper surface and the lower surface is operable to engage a toilet seat, and a tip extending upward from the upper surface of the front lateral side above an upper surface of the toilet seat; and a second toilet seat adapter comprising a lateral cross-member configured to extend between a first lateral side of a toilet seat and a second lateral side of the toilet seat, and a protrusion extending from an upper surface of the lateral cross-member The first toilet seat adapter can further comprise a first curved surface configured to contact a first exterior curved surface of the toilet seat and a second curved surface configured to contact a second exterior curved surface of the toilet seat. The first toilet seat adapter can further comprise comprising an adhesive for securing the toilet seat adapter to the toilet seat. The first toilet seat adapter further comprises a suction cup for securing the toilet seat adapter to the toilet seat. Additionally, the tip of the first toilet seat adapter is flexible. The tip of the first toilet seat adapter can also be configured to have a first width at a distal end and a second width larger that the first width proximal to the distal end. In some configurations, the tip of the first toilet seat adapter is laterally moveable. The protrusion of the second toilet seat adapter can also be positioned on a stem to provide an adjustable height. A counterweight can be provided that is positioned on an opposing end of the stem engaging the protrusion.

### III. Methods of Using Disclosed Toilet Seats, Adapters, and Systems

As discussed above, FIG. 1B illustrates an exemplary partial internal view of a human with the organs that assist in a bowel movement. A first arrow 30 indicates the location of the first pressure applying projection between the rectal outlet and the tailbone in order to apply pressure against the pelvic floor. The second arrow 32 indicates a location of the second pressure applying projection on the opposite side of the rectal outlet than the first projection. The second projection is positioned to contact an area in front of the user's rectal outlet toward the puborectalis muscle. One or more of the added pressure may be configured to straighten or align the passage before the rectal outlet to assist in an easier bowel movement or a more complete excretion of material from the rectum. As will be appreciated by those skilled in the art, either or both of the pressure applying projections can be provided in the toilet seat to apply pressure to one or both of an area between the rectal outlet and the tailbone and an area in front of the user's rectal outlet toward the puborectalis muscle.

The method of using a toilet seat includes providing a toilet seat with the one or more projections as described above. The toilet seat may have the projection already integrated into the toilet seat, or the projection may be provided as part of an adapter. The adapter can be, for example, rotationally positioned relative to the toilet seat.

When a rotationally positioned adapter is provided, the toilet seat may simply be orientated into a use position, and the projection oriented to facilitate applying pressure to the target anatomical area(s). For removable adapter, the projection may be attached or coupled to the toilet seat by the user prior to use.

Additionally, the pressure applying projections can be adjusted by moving forward or backwards or up and down, to achieve the desired pressure application.

Once the one or more projections are in a target position and orientation, the user may sit on the toilet seat. The one or more projection may be positioned on either side of the rectal outlet of the user. The projections may also be adjusted to an orientation, height, or other position. For example, the projection may be elevated by selecting a different aperture in which the stem is positioned according to embodiments described herein. The orientation may be selected by rotationally moving the projection into a target angle. Once positioned, the user may sit on the toilet seat and the one or more projections contact the user proximate the rectal outlet and apply pressure to the area adjacent to the rectal outlet. The user may then defecate through an opening in the toilet seat past the projections and into a lower portion of the toilet.

When a user sits on a disclosed toilet seat or a toilet seat with a disclosed adapter, pressure is applied at either or both of the first pressure location and the second pressure location represented by first arrow 30 and second arrow 32. Application of pressure helps the bowel movement exit the rectum through the anal sphincter and the rectal outlet. The projections described herein are configured to press against and in the space between the rectal outlet and the tailbone of a user as the user sits on the toilet seat portion and the projection is in an in use position (either integrated with the toilet seat, coupled to the toilet seat, or rotationally positioned in contact with the toilet seat, or otherwise configured to be used). Moreover, the projections are configured, sized, and positioned, in order to press in the area between either the tail bone and the anal sphincter or the rectal outlet and the puborectalis muscle to facilitate straightening the passage between the rectum and the rectal outlet which in turn assists in the excretion of material from the rectum.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

1. A toilet seat comprising:
an upper surface, a lower surface, a first lateral side, a second lateral side and a rear lateral side between the first lateral side and the second lateral side;
a toilet seat opening defined between the first lateral side, the second lateral side, and the rear lateral side;
a convex upward extending surface from the rear lateral side of the upper surface; and
a concave curved surface positioned on the rear lateral side of the upper surface adjacent the convex upward extending surface,
wherein the upper surface, lower surface, first lateral side, second lateral side, rear lateral side and toilet seat opening of the toilet seat define a curved outer edge from a top view, and a curved inner edge from the top view,
wherein the upper surface of the rear lateral side curves downward from the outer edge of the rear lateral side from a side view into the convex surface, and then curves upward into the concave curved surface.

2. The toilet seat of claim 1 further comprising a front lateral side.

3. The toilet seat of claim 1 further comprising a tip on the concave curved surface.

4. The toilet seat of claim 1 wherein the concave curved surface is moveable in a forward and backward direction.

5. The toilet seat of claim 1 further comprising a lid rotatably connected to the toilet seat.

6. The toilet seat of claim 1 further comprising a lateral cross-member extending between the first lateral side and the second lateral side.

7. The toilet seat of claim 6 wherein the lateral cross-member has a protrusion extending from an upper surface of the lateral cross-member.

8. The toilet seat of claim 7 wherein the protrusion is positioned on a stem to provide an adjustable height.

9. The toilet seat of claim 8 further comprising a counterweight positioned on an opposing end of the stem engaging the protrusion.

10. A toilet seat comprising:
an upper surface, a lower surface, a first lateral side, a second lateral side and a rear lateral side between the first lateral side and the second lateral side;
a toilet seat opening defined between the first lateral side, the second lateral side, and the rear lateral side; and
a lateral cross-member extending between the first lateral side and the second lateral side; and a protrusion extending from an upper surface of the lateral cross-member.

11. The toilet seat of claim 10 further comprising a front lateral side.

12. The toilet seat of claim 10 further comprising a lid rotatably connected to the toilet seat.

13. The toilet seat of claim 10 further comprising:
a convex surface extending upward from the rear lateral side of the upper surface; and
a concave curved surface positioned on the rear lateral side of the upper surface adjacent the convex upward extending surface.

14. The toilet seat of claim 13 wherein the upper surface of the rear lateral side curves downward from an outer edge of the rear lateral side from a side view into the convex surface, and then curves upward into the concave curved surface.

15. The toilet seat of claim 13 further comprising a tip on the concave curved surface.

16. The toilet seat of claim 13 wherein the concave curved surface is moveable in a forward and backward direction.

17. The toilet seat of claim 10 wherein the protrusion is positioned on a stem to provide an adjustable height.

18. The toilet seat of claim 17 further comprising a counterweight positioned on an opposing end of the stem engaging the protrusion.

19. A toilet seat adapter comprising:
an upper surface, a lower surface, a first lateral side, a second lateral side and a rear lateral side between the first lateral side and the second lateral side and a front lateral side between the first lateral side and the second lateral side at opposite the rear lateral side, wherein one of the upper surface and the lower surface is operable to engage a toilet seat; and
a tip extending upward from the upper surface of the front lateral side above an upper surface of the toilet seat.

20. The toilet seat adapter of claim 19 further comprising a first curved surface configured to contact a first exterior curved surface of the toilet seat and a second curved surface configured to engage a second exterior curved surface of the toilet seat.

21. The toilet seat adapter of claim 19 further comprising an adhesive for securing the toilet seat adapter to the toilet seat.

22. The toilet seat adapter of claim 19 further comprising a suction cup for securing the toilet seat adapter to the toilet seat.

23. The toilet seat adapter of claim 19 wherein the tip is flexible.

24. The toilet seat adapter of claim 19 wherein the tip has a first width at a distal end and a second width larger that the first width proximal to the distal end.

25. The toilet seat adapter of claim 19 wherein the tip is laterally moveable.

26. A toilet seat adapter comprising:
a lateral cross-member configured to extend between a first lateral side of a toilet seat and a second lateral side of the toilet seat; and
a protrusion extending from an upper surface of the lateral cross-member.

27.-28. (canceled)

29. A toilet seat adapter system comprising:
a first toilet seat adapter comprising
an upper surface, a lower surface, a first lateral side, a second lateral side and a rear lateral side between the first lateral side and the second lateral side and a front lateral side between the first lateral side and the second lateral side at opposite the rear lateral 5 side, wherein one of the upper surface and the lower surface is operable to engage a toilet seat, and
a tip extending upward from the upper surface of the front lateral side above an upper surface of the toilet seat; and
a second toilet seat adapter comprising
a lateral cross-member configured to extend between a first lateral side of the toilet seat and a second lateral side of the toilet seat, and
a protrusion extending from an upper surface of the lateral cross-member.

30.-37. (canceled)
